(19) United States
(12) Patent Application Publication
(10) Pub. No.: US 2019/0258059 A1
(43) Pub. Date: Aug. 22, 2019

(54) VEHICULAR DISPLAY DEVICE

(71) Applicant: Yazaki Corporation, Tokyo (JP)

(72) Inventor: Nobuyuki TAKAHASHI, Shizuoka (JP)

(73) Assignee: Yazaki Corporation, Tokyo (JP)

(21) Appl. No.: 16/280,194

(22) Filed: Feb. 20, 2019

(30) Foreign Application Priority Data
Feb. 21, 2018 (JP) 2018-028637

(51) Int. Cl. G02B 27/01

(52) U.S. Cl. CPC G02B 27/0149; B60K 35/00; G02B 2027/015; G02B 27/0101

(57) ABSTRACT

A vehicular display device includes a display that emits, as display light, a display image projected onto a windshield, a transparent cover that blocks an opening of a housing and transmits the display light, and a reflecting mirror that reflects the display light at a position where an optical path of the display light from the display to the windshield is folded back. The transparent cover includes a light shielding wall disposed on an optical path of external light incident from an outside of a vehicle, reflected by the transparent cover, and directed from the transparent cover to an eye point via the windshield, reflects the display light emitted from the display toward the reflecting mirror, transmits the display light reflected from the reflecting mirror toward the windshield, and reflects the external light toward the light shielding wall.

### CROSS-REFERENCE TO RELATED APPLICATION(S)

The present application claims priority to and incorporates by reference the entire contents of Japanese Patent Application No. 2018-028637 filed in Japan on Feb. 21, 2018.

### BACKGROUND OF THE INVENTION

### 1. Field of the Invention

The present invention relates to a vehicular display device.

### 2. Description of the Related Art

According to the related art, some vehicles such as automobiles are equipped with a vehicular display device such as a head up display (HUD) device. The head up display device projects a display image displayed on a display onto a windshield or a combiner via a reflecting mirror or the like, and then a driver can visually recognize the display image as a virtual image (see, for example, Japanese Patent Application Laid-open No. 2016-587. In the vehicular display device disclosed in Japanese Patent Application Laid-open No. 2016-587, a display image-transmitting transparent cover is provided in an instrument panel opening portion, and the transparent cover blocks dust or the like from entering the inside of the device.

Nowadays, aspherical concave mirrors are used as reflecting mirrors in vehicular display devices for an increase in display image size. However, an increase in magnification based on an increase in reflecting mirror curvature is not without limitations. Although this can be dealt with by arrangement of a plurality of reflecting mirrors, an increase in the size of a housing accommodating the plurality of reflecting mirrors may arise in that case.

### SUMMARY OF THE INVENTION

An object of the present invention is to provide a vehicular display device with which a display screen can be expanded and a housing can be reduced in size.

In order to solve the above mentioned problem and achieve the object, a vehicular display device according to one aspect of the present invention includes a display that emits, as display light, a display image projected onto a projected member provided in a vehicle; a cover member that blocks an opening provided in a housing and transmits at least a part of the display light; and a reflecting member that reflects the display light at a position where an optical path of the display light from the display to the projected member is folded back, wherein the cover member includes a light shielding wall erected in a front edge portion of the vehicle in a forward-rearward direction and disposed on an optical path of external light incident from an outside of the vehicle, reflected by the cover member, and directed from the cover member to an eye point of a driver of the vehicle via the projected member, and the cover member reflects the display light emitted from the display toward the reflecting member, transmits the display light reflected from the reflecting member toward the projected member, and reflects the external light toward the light shielding wall.

According to another aspect of the present invention, in the vehicular display device, it is preferable that the cover member has a convex curved surface shape protruding toward an inside of the housing.

According to still another aspect of the present invention, in the vehicular display device, it is preferable that the cover member has a convex curved surface shape tilted to a front side in the forward-rearward direction and protruding toward an inside of the housing.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicular display device according to a first embodiment;

FIG. 2 is a schematic configuration diagram of a vehicular display device according to a modification example of the first embodiment;

FIG. 3 is a schematic configuration diagram of a vehicular display device according to a second embodiment;

FIG. 4 is a schematic diagram illustrating a change in display light of the vehicular display device according to the second embodiment;

FIG. 5 is a schematic configuration diagram of a vehicular display device according to a third embodiment; and

FIG. 6 is a schematic diagram illustrating a change in display light of the vehicular display device according to the third embodiment.

### DETAILED DESCRIPTION OF THE PREFERRED EMBODIMENTS

Hereinafter, embodiments of a vehicular display device according to the present invention will be described in detail with reference to accompanying drawings. It should be noted that the present invention is not limited by the embodiments. In addition, constituent elements in the following embodiments include those that can be easily assumed by those skilled in the art or those that are substantially identical. In addition, various omissions, replacements, and changes can be made to the constituent elements in the following embodiments without departing from the gist of the invention.

### First Embodiment

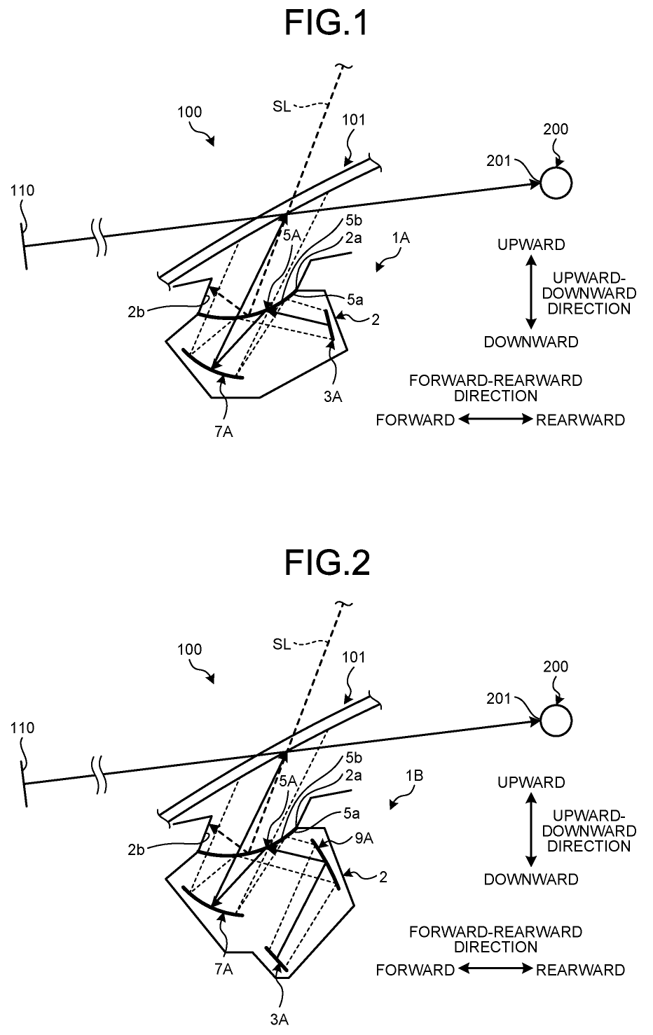

First, a vehicular display device 1A according to a first embodiment will be described with reference to FIG. 1. FIG. 1 is a schematic configuration diagram of the vehicular display device 1A according to the first embodiment. The vehicular display device 1A is a head up display device that is disposed inside an instrument panel (not illustrated) of a vehicle 100 such as an automobile and projects a display image onto a windshield 101. The vehicular display device 1A projects a display image onto the windshield 101 as a projected member and displays a virtual image 110 in front of an eye point 201 of a driver 200. The windshield 101, which has semi-transmissive properties, reflects a part of incident light and transmits the other part. Specifically, while transmitting the foreground of the vehicle 100, the windshield 101 reflects a display image projected from the vehicular display device 1A to the eye point 201 of the driver 200 as display light. The windshield 101 is disposed above the instrument panel of the vehicle 100. The eye point 201 is presumed as a viewpoint position of the driver 200 of the vehicle 100. The driver 200 recognizes the display image reflected by the windshield 101 as the virtual image 110. For the driver 200, the virtual image 110 is recognized in front of the windshield 101. The vehicular display device 1A is configured to include a housing 2, a display 3A, a transparent cover 5A, and a reflecting mirror 7A.

Unless otherwise noted, in this specification, the “forward-rearward direction” indicates the forward-rearward direction of the vehicle 100 equipped with the vehicular display device 1A. Unless otherwise noted, the “upward-downward direction” indicates the upward-downward direction of the vehicle 100 and the “width direction” indicates the vehicle width direction of the vehicle 100.

The housing 2 has an inner portion formed in a hollow box shape and an internal space accommodating the display 3A, the reflecting mirror 7A, and so on. The housing 2 has an opening 2a, which is a part of the optical path of the display light that is emitted toward the windshield 101. The opening 2a is at a position facing the windshield 101 and allows the display light to pass toward the windshield 101.

The display 3A emits a display image projected onto the windshield 101 of the vehicle 100 as display light. The display 3A is configured to include, for example, a liquid crystal panel (not illustrated) and a backlight unit (not illustrated). The liquid crystal panel is made of, for example, a light-transmissive or semi-light-transmissive thin film transistor (TFT) liquid crystal display. When the liquid crystal panel is illuminated from the back surface side of the liquid crystal panel, the display surface on the surface side of the liquid crystal panel emits light. The backlight unit illuminates the liquid crystal panel from the back surface side. The backlight unit is driven by, for example, electric power obtained from a battery (not illustrated) in the vehicle 100.

The transparent cover 5A is a cover member that blocks the opening 2a provided in the housing 2 and transmits at least a part of the display light. By blocking the opening 2a, the transparent cover 5A prevents dust and the like from entering the housing 2 from the outside. The transparent cover 5A is made of a light-transmitting member transmitting the display light emitted from the display 3A, examples of which include a synthetic resin such as polycarbonate, acryl, and glass. The transparent cover 5A of the present embodiment is configured to reflect the display light emitted from the display 3A toward the reflecting mirror 7A in a blocked state where the opening 2a is blocked (hereinafter, simply referred to as the “blocked state” in some cases). Meanwhile, the transparent cover 5A of the present embodiment is configured to transmit the display light reflected from the reflecting mirror 7A toward the windshield 101 in the blocked state.

The transparent cover 5A has the shape of a convex curved surface protruding toward the inside of the housing 2. The transparent cover 5A has a convex curved surface 5a protruding toward the inside of the housing 2 and a concave curved surface 5b provided on the surface on the side opposite to the convex curved surface 5a and concave outward from the housing 2. The convex curved surface 5a and the concave curved surface 5b are configured by means of, for example, an aspherical surface (including a free-form surface). The convex curved surface 5a of the present embodiment has a shape correcting a field curvature aberration resulting from the effect of at least one of a curved surface in an optical system such as the reflecting mirror 7A (including a reflecting surface and a transmission surface) and the surface shape of the windshield 101 of the vehicle 100. The concave curved surface 5b of the present embodiment has a function as a reflecting mirror that reflects external light SL incident upon the transparent cover 5A from the outside of the vehicle 100. In other words, the concave curved surface 5b reflects the external light SL incident upon the transparent cover 5A toward a direction different from the eye point direction toward the eye point 201 of the driver 200. For example, the concave curved surface 5b reflects the incident external light SL toward a light shielding wall 2b. Here, the external light SL is, for example, sunlight or street lamp light incident upon the inside of the vehicle from the outside of the vehicle 100. The thickness between the convex curved surface 5a and the concave curved surface 5b, that is, the thickness of the transparent cover 5A is preferably increased in view of strength. In a case where the thickness is increased, however, the back surface reflection of the convex curved surface 5a and the concave curved surface 5b may significantly affect the display image. Accordingly, the thickness is preferably a thickness taking the possibility into account.

The transparent cover 5A has the light shielding wall 2b erected in the front edge portion of the vehicle 100 in the forward-rearward direction. The light shielding wall 2b is disposed on the optical path of the external light SL that is incident from the outside of the vehicle 100, reflected by the transparent cover 5A, and directed from the transparent cover 5A to the eye point 201 of the driver 200 of the vehicle 100 via the windshield 101. The transparent cover 5A reflects the external light SL incident from the outside of the vehicle 100 toward the light shielding wall 2b.

The reflecting mirror 7A is at a position where the optical path of the display light from the display 3A to the windshield 101 is folded back and reflects the display light. The reflecting mirror 7A is an optical system that changes the optical path of the display light emitted from the display 3A in the housing 2. The reflecting mirror 7A is a magnifying mirror that magnifies and reflects the display image represented by the display light. The reflecting mirror 7A is formed of, for example, an aspherical mirror that has a concave reflecting surface. In other words, the reflecting mirror 7A magnifies and reflects the display image such that the display image represented by the display light after reflection by the reflecting mirror 7A becomes relatively larger than the display image represented by the display light before reflection by the reflecting mirror 7A. The reflecting mirror 7A of the present embodiment is a final reflecting mirror that totally reflects the display light reflected by the transparent cover 5A toward the windshield 101. Although the reflecting mirror 7A is fixed to the housing 2, the reflecting mirror 7A may be supported by an adjustment mechanism for finely adjusting the reflection angle of display light with which the windshield 101 is irradiated.

Next, a display operation of the vehicular display device 1A according to the present embodiment will be described with reference to FIG. 1. First, the display light emitted from the display 3A is directed to the transparent cover 5A. The transparent cover 5A reflects the display light emitted from the display 3A toward the reflecting mirror 7A by the convex curved surface 5a. The display light incident upon the reflecting mirror 7A is totally reflected by the concave reflecting surface and directed to the transparent cover 5A again. The transparent cover 5A transmits the display light incident from the reflecting mirror 7A from the convex curved surface 5a toward the windshield 101 via the concave curved surface 5b. As a result, the display image is projected onto the windshield 101 and the virtual image 110 is displayed in front of the eye point 201 of the driver 200.

The vehicular display device 1A described above has the transparent cover 5A that blocks the opening 2a of the housing 2. The transparent cover 5A reflects the display light emitted from the display 3A toward the reflecting mirror 7A and transmits the display light reflected from the reflecting mirror 7A toward the windshield 101. By reflecting the display light on a transparent cover 5A in this manner, it is possible to extend the optical path length of the display light, and it is possible to magnify a display screen by magnifying the display image representing the display light with the lengthened optical path length. In addition, the housing 2 can be reduced in size as it is possible to extend the optical path length of the display light without adding any new optical system component. In addition, far-viewpoint display of the display image is facilitated based on the extension of the optical path length of the display light. In addition, in the vehicular display device 1A, the transparent cover 5A has the light shielding wall 2b disposed on the optical path of the external light SL that is reflected by the transparent cover 5A and directed from the transparent cover 5A to the eye point 201 via the windshield 101. As a result, the external light SL that is reflected by the transparent cover 5A and directed to the eye point 201 of the driver 200 can be shielded by the light shielding wall 2b, and a phenomenon can be prevented in which the virtual image 110 displayed on the windshield 101 has a double or blurred appearance (so-called ghost phenomenon).

### Modification Example of First Embodiment

Next, a vehicular display device 1B according to a modification example of the first embodiment will be described with reference to FIG. 2. FIG. 2 is a schematic diagram illustrating a schematic configuration of the vehicular display device 1B according to the modification example of the first embodiment. The vehicular display device 1B according to the present modification example is different from the vehicular display device 1A illustrated in FIG. 1 in that a reflecting mirror 9A is added. In other words, the vehicular display device 1B is configured to include the housing 2, the display 3A, the transparent cover 5A, and the two reflecting mirrors 7A and 9A. Incidentally, the same reference numerals are given to the configurations that are identical to those of the first embodiment, and description thereof will be omitted (the same applies to the following embodiments).

As is the case with the reflecting mirror 7A, the reflecting mirror 9A is at a position where the optical path of the display light from the display 3A to the windshield 101 is folded back and reflects the display light. As is the case with the reflecting mirror 7A, the reflecting mirror 9A is an optical system that changes the optical path of the display light emitted from the display 3A in the housing 2. As is the case with the reflecting mirror 7A, the reflecting mirror 9A is a magnifying mirror and is formed of, for example, an aspherical mirror that has a concave reflecting surface. The reflecting mirror 9A of the present modification example is an intermediate bending mirror that totally reflects the display light emitted from the display 3A toward the transparent cover 5A.

Next, a display operation of the vehicular display device 1B according to the present modification example will be described with reference to FIG. 2. First, the display light emitted from the display 3A is incident upon the reflecting mirror 9A. The display light incident upon the reflecting mirror 9A is totally reflected by the concave reflecting surface and directed to the transparent cover 5A. The transparent cover 5A reflects the display light incident from the reflecting mirror 9A toward the reflecting mirror 7A by the convex curved surface 5a. The display light incident upon the reflecting mirror 7A is totally reflected by the concave reflecting surface and directed to the transparent cover 5A again. The transparent cover 5A transmits the display light incident from the reflecting mirror 7A from the convex curved surface 5a toward the windshield 101 via the concave curved surface 5b. As a result, the display image is projected onto the windshield 101 and the virtual image 110 is displayed in front of the eye point 201 of the driver 200.

As compared with the vehicular display device 1A, the vehicular display device 1B described above has the additional reflecting mirror 9A. Accordingly, it is possible to further extend the optical path length of the display light and further magnify the display screen. In addition, far-viewpoint display of the display image is facilitated based on the extension of the optical path length of the display light.

Although the reflecting mirrors 7A and 9A have a function as a magnifying mirror in the above-described first embodiment and modification example, the present invention is not limited thereto, and the reflecting mirrors 7A and 9A may also have a function as a correction mirror performing reflection after correcting the distortion of the display image that is attributable to the windshield 101 or the optical system. The reflecting mirrors 7A and 9A that function as the magnifying mirror and the correction mirror are formed as free-form surface mirrors having shapes asymmetrical with respect to an optical axis unlike a spherical surface and a paraboloid.

In addition, in the first embodiment and the modification example, the transparent cover 5A has a shape in which the convex curved surface 5a corrects a field curvature aberration. For example, the convex curved surface 5a is formed in a shape corresponding to the shape of the projected surface of the windshield 101 and the geometrical positional relationship of a reflecting mirror 7A with respect to the projected surface and optically corrects distortion such that the display image represented by the display light has a desired shape when the display light is reflected toward the windshield 101. As a result, it is possible to correct distortion of the display image represented by the display light by display light reflection on the convex curved surface 5a of the transparent cover 5A, and display quality improvement can be achieved.

### Second Embodiment

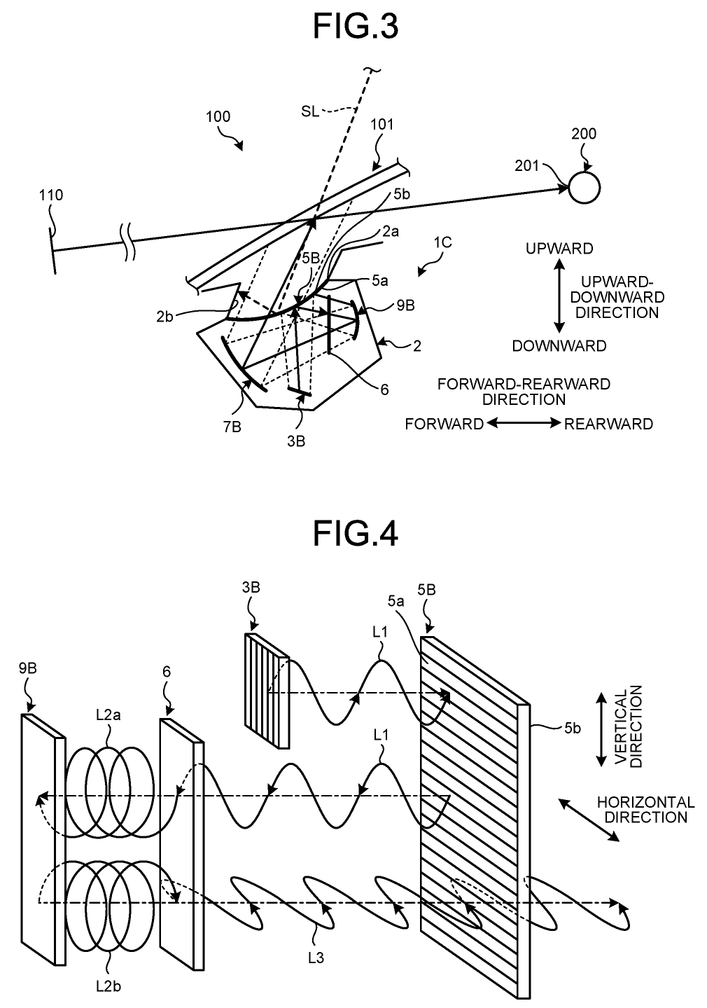

Next, a vehicular display device 1C according to a second embodiment of the present invention will be described with reference to FIGS. 3 and 4. FIG. 3 is a schematic configuration diagram of the vehicular display device according to the second embodiment. FIG. 4 is a schematic diagram illustrating a change in display light of the vehicular display device according to the second embodiment. Incidentally, a reflecting mirror 7B is not illustrated in the schematic diagram illustrated in FIG. 4. The vehicular display device 1C according to the present embodiment differs from the vehicular display device 1A in that the vehicular display device 1C is provided with a display 3B that emits linearly polarized light and a transparent cover 5B having a polarization function and a quarter wave plate 6 and a reflecting mirror 9B are added to the vehicular display device 1C. In other words, the vehicular display device 1C is configured to include the housing 2, the display 3B, the transparent cover 5B, the quarter wave plate 6, and the two reflecting mirrors 7B and 9B.

The display 3B emits a display image projected onto the windshield 101 provided in the vehicle 100 as display light. The display 3B is configured to include, for example, a liquid crystal panel (not illustrated) and a backlight unit (not illustrated). The liquid crystal panel is made of, for example, a light-transmissive or semi-light-transmissive thin film transistor (TFT) liquid crystal display. When the liquid crystal panel is illuminated from the back surface side of the liquid crystal panel, the display surface on the surface side of the liquid crystal panel emits light. The backlight unit illuminates the liquid crystal panel from the back surface side. The backlight unit is driven by, for example, electric power obtained from a battery (not illustrated) in the vehicle 100. As illustrated in FIG. 4, the display 3B of the present embodiment emits linearly polarized light vibrating in a reference vibration direction as display light L1. Here, the reference vibration direction is, for example, a vertical direction and a direction parallel to the polarizing axis of the display 3B. In other words, the display 3B has a polarizing axis in the vertical direction and emits the display light L1 parallel to the polarizing axis. For example, the display 3B is disposed such that the polarizing axis (transmission axis) of one of the polarizing plates that constitute the liquid crystal panel, which is on the light emitting side, is in the vertical direction.

The transparent cover 5B is a cover member that blocks the opening 2a provided in the housing 2 and transmits at least a part of the display light emitted from the display 3B. By blocking the opening 2a, the transparent cover 5B prevents dust and the like from entering the housing 2 from the outside. The transparent cover 5B is made of a light-transmitting member transmitting the display light emitted from the display 3B, examples of which include a synthetic resin such as polycarbonate, acryl, and glass, and a polarizing member combined with the member. The polarizing member includes, for example, a polarizing film. The polarizing film is affixed to the convex curved surface 5a side of the transparent cover 5B and combined with the light-transmitting member. The polarizing member typically has a polarizing axis, transmits light vibrating in parallel with the polarizing axis, and reflects light vibrating in a direction orthogonal to the polarizing axis. In other words, as illustrated in FIG. 4, the transparent cover 5B has a polarizing axis in the horizontal direction orthogonal to the vertical direction, transmits display light L3 vibrating in a direction parallel to the polarizing axis (direction orthogonal to the reference vibration direction), and reflects the display light L1 vibrating in a direction orthogonal to the polarizing axis (reference vibration direction). The transparent cover 5B of the present embodiment is configured to reflect the display light emitted from the display 3B toward the quarter wave plate 6 and transmit the display light reflected from the reflecting mirror 7B toward the windshield 101.

The transparent cover 5B has the shape of a convex curved surface protruding toward the inside of the housing 2. The transparent cover 5B has a convex curved surface 5a protruding toward the inside of the housing 2 and a concave curved surface 5b provided on the surface on the side opposite to the convex curved surface 5a and concave outward from the housing 2. The convex curved surface 5a and the concave curved surface 5b are configured by means of, for example, an aspherical surface (including a free-form surface). The convex curved surface 5a of the present embodiment has a shape correcting a field curvature aberration resulting from the effect of at least one of a curved surface in an optical system such as the reflecting mirror 7A (including a reflecting surface and a transmission surface) and the surface shape of the windshield 101 of the vehicle 100. The concave curved surface 5b of the present embodiment has a function as a reflecting mirror that reflects external light SL incident upon the transparent cover 5A from the outside of the vehicle 100. In other words, the concave curved surface 5b reflects the external light SL incident upon the transparent cover 5A toward a direction different from the eye point direction toward the eye point 201 of the driver 200. For example, the concave curved surface 5b reflects the incident external light SL toward a light shielding wall 2b. The thickness between the convex curved surface 5a and the concave curved surface 5b, that is, the thickness of the transparent cover 5B is preferably increased in view of strength. In a case where the thickness is increased, however, the back surface reflection of the convex curved surface 5a and the concave curved surface 5b may significantly affect the display image. Accordingly, the thickness is preferably a thickness taking the possibility into account.

The transparent cover 5B has the light shielding wall 2b erected in the front edge portion of the vehicle 100 in the forward-rearward direction. The light shielding wall 2b is disposed on the optical path of the external light SL that is incident from the outside of the vehicle 100, reflected by the transparent cover 5B, and directed from the transparent cover 5B to the eye point 201 of the driver 200 of the vehicle 100 via the windshield 101. The transparent cover 5B reflects the external light SL incident from the outside of the vehicle 100 toward the light shielding wall 2b.

The quarter wave plate 6 is disposed at a position that is on the optical path of the display light from a display 3B to the windshield 101 and faces the reflecting mirror 9B. The quarter wave plate 6 transmits the display light incident from the transparent cover 5B and transmits the display light incident from the reflecting mirror 9B. The quarter wave plate 6 is a type of so-called wave plate, and a birefringent material or the like constitutes the quarter wave plate 6. The quarter wave plate 6 is obtained by giving a phase difference (optical path difference) to two linearly polarized light beams that have vibration directions orthogonal to each other. The quarter wave plate 6 of the present embodiment converts the display light L1 incident from the transparent cover 5B and transmitted to the reflecting mirror 9B side into display light L2a (circularly polarized light) vibrating in a direction tilted by 45° with respect to the reference vibration direction. In other words, as illustrated in FIG. 4, the quarter wave plate 6 converts the linearly polarized light (display light L1) reflected by the convex curved surface 5a of the transparent cover 5B into circularly polarized light (display light L2a) that is counterclockwise and tilted by 45°. In addition, the quarter wave plate 6 converts display light L2b reflected by the reflecting mirror 9B and transmitted toward the reflecting mirror 7B into the display light L3 (second linearly polarized light) vibrating in a direction orthogonal to the reference vibration direction. In other words, as illustrated in FIG. 4, the quarter wave plate 6 converts the circularly polarized light (display light L2b) reflected by the reflecting surface of the reflecting mirror 9B into linearly polarized light (display light L3) orthogonal to the reference vibration direction. In this manner, the quarter wave plate 6 converts transmitted linearly polarized light into circularly polarized light and converts transmitted circularly polarized light into linearly polarized light. Here, the display light L2b is circularly polarized light whose rotation direction is opposite to that of the circularly polarized light which is the display light L2a. In other words, once reflected by the reflecting mirror 9B, the display light L2a is converted into the circularly polarized display light L2b rotating in the opposite direction.

The reflecting mirrors 7B and 9B are at positions where the optical path of the display light from the display 3B to the windshield 101 is folded back and reflect the display light. The reflecting mirrors 7B and 9B are optical systems that change the optical path of the display light emitted from the display 3B in the housing 2. The reflecting mirrors 7B and 9B of the present embodiment are magnifying mirrors that magnify and reflect the display image represented by the display light. The reflecting mirrors 7B and 9B are formed of, for example, a concave curved surface (or convex curved surface) mirror having an aspherical reflecting surface. In other words, the reflecting mirrors 7B and 9B magnify and reflect the display image such that the display image represented by the display light after reflection by the reflecting mirrors 7B and 9B becomes relatively larger than the display image represented by the display light before reflection by the reflecting mirrors 7B and 9B. The reflecting mirror 9B of the present embodiment is an intermediate bending mirror that totally reflects the display light reflected by the transparent cover 5B and transmitted through the quarter wave plate 6 again toward the reflecting mirror 7B by transmission through the quarter wave plate 6. The reflecting mirror 7B of the present embodiment is a final reflecting mirror that totally reflects the display light incident through the quarter wave plate 6 toward the windshield 101 disposed on the opposite side with the transparent cover 5B between the reflecting mirror 7B and the windshield 101. Although the reflecting mirror 7B is fixedly supported by the housing 2, the reflecting mirror 7B may be supported by an adjustment mechanism for finely adjusting the reflection angle of display light with which the windshield 101 is irradiated.

Next, a display operation of the vehicular display device 1C will be described with reference to FIG. 3. First, the display light emitted from the display 3B is directed to the transparent cover 5B. The transparent cover 5B reflects the display light incident from the display 3B toward the quarter wave plate 6 by the convex curved surface 5a. The quarter wave plate 6 transmits the display light incident from the transparent cover 5B toward the reflecting mirror 9B. The display light incident upon the reflecting mirror 9B is totally reflected by the concave reflecting surface and directed to the quarter wave plate 6. The quarter wave plate 6 transmits the display light incident from the reflecting mirror 9B toward the reflecting mirror 7B. The display light incident upon the reflecting mirror 7B is totally reflected by the concave reflecting surface and directed to the transparent cover 5B again. The transparent cover 5B transmits the display light incident from the reflecting mirror 7B from the convex curved surface 5a toward the windshield 101 via the concave curved surface 5b. As a result, the display image is projected onto the windshield 101 and the virtual image 110 is displayed in front of the eye point 201 of the driver 200.

In the vehicular display device 1C described above, the transparent cover 5B has a polarization structure to transmit the second linearly polarized light converted from first linearly polarized light toward the windshield 101 by reflecting the first linearly polarized light emitted from the display 3B and transmitting the first linearly polarized light by folding back the quarter wave plate 6. By the transparent cover 5B being given a function as a polarizing plate and the display light being reflected on the transparent cover 5B in this manner, it is possible to extend the optical path length of the display light, and it is possible to magnify a display screen by magnifying the display image representing the display light with the lengthened optical path length. In addition, the housing 2 can be reduced in size as it is possible to extend the optical path length of the display light without adding any new optical system component. In addition, far-viewpoint display of the display image is facilitated based on the extension of the optical path length of the display light. Further, the transparent cover 5B reflects (or absorbs) the linearly polarized light that constitutes the external light SL and vibrates in the reference vibration direction, and thus the external light SL that reaches the display 3B via the reflecting mirrors 7B and 9B or the like decreases and a rise in the temperature of the display 3B attributable to incidence of the external light SL can be suppressed.

In addition, in the vehicular display device 1C, the transparent cover 5B has the light shielding wall 2b disposed on the optical path of the external light SL that is reflected by the transparent cover 5B and directed from the transparent cover 5B to the eye point 201 via the windshield 101. As a result, the external light SL that is reflected by the transparent cover 5B and directed to the eye point 201 of the driver 200 can be shielded by the light shielding wall 2b, and a phenomenon can be prevented in which the virtual image 110 displayed on the windshield 101 has a double or blurred appearance (so-called ghost phenomenon).

In addition, in the vehicular display device 1C, the display 3B emits linearly polarized light vibrating in the reference vibration direction as display light. As a result, it is possible to, for example, reflect or transmit the display light emitted from the display 3B by means of the transparent cover 5B.

In addition, in the vehicular display device 1C, the transparent cover 5B reflects linearly polarized light vibrating in the reference vibration direction and transmits linearly polarized light vibrating in a direction orthogonal to the reference vibration direction. As a result, it is possible to extend the optical path length of the display light by reflecting the display light on the transparent cover 5B and it is possible to emit the display light from the housing 2 toward the windshield 101 by transmitting the display light through the transparent cover 5B.

In addition, in the vehicular display device 1C, the transparent cover 5B is configured by combination of a light-transmitting member and a polarizing film, and thus product manufacturing can be facilitated and an increase in cost can be suppressed.

In the modification example of the first embodiment and the second embodiment, each of the vehicular display devices 1B and 1C has two reflecting mirrors. However, the present invention is not limited thereto, and each of the vehicular display devices 1B and 1C may have three or more reflecting mirrors instead.

In the first embodiment, the modification example, and the second embodiment, the display image is projected onto the windshield 101 of the vehicle 100. However, the present invention is not limited thereto, and the display image may be projected onto a combiner or the like instead.

### Third Embodiment

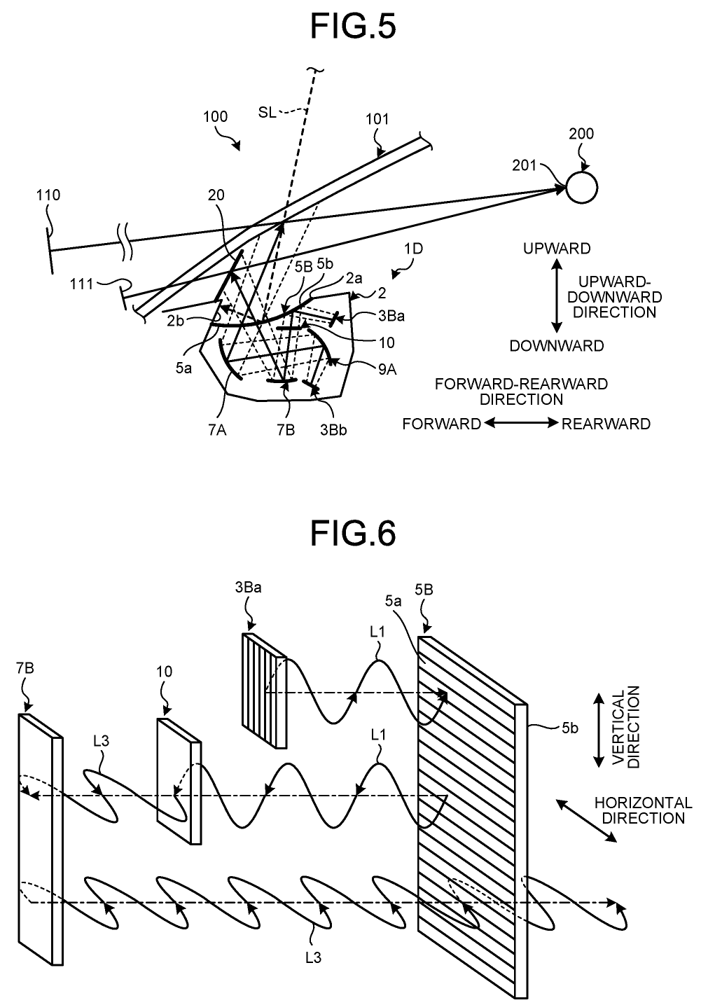

Next, a vehicular display device 1D according to a third embodiment of the present invention will be described with reference to FIGS. 5 and 6. FIG. 5 is a schematic configuration diagram of the vehicular display device according to the third embodiment. FIG. 6 is a schematic diagram illustrating a change in display light of the vehicular display device according to the third embodiment. Incidentally, illustrated in FIG. 6 is the optical path of the display light from a display 3Ba to a combiner 20 illustrated in FIG. 5. The vehicular display device 1D according to the present embodiment differs from the vehicular display device 1A in that the vehicular display device 1D is provided with the display 3B and the transparent cover 5B and a half wave plate 10 is added to the vehicular display device 1D. Incidentally, the vehicular display device 1D illustrated in FIG. 5 has two displays 3Ba and 3Bb and has the optical path of the display light from the display 3Ba to the combiner 20 and the optical path of the display light from a display 3Bb to the windshield 101. Here, the combiner 20 is a projected member and is a concave mirror made of, for example, a half mirror molded in a rectangular shape. The combiner 20, which has semi-transmissive properties, reflects a part of incident light and transmits the other part. The vehicular display device 1D projects a display image onto the combiner 20 and displays a virtual image 111 in front of the eye point 201 of the driver 200. The combiner 20 is erected in the front edge portion of the housing 2 in the forward-rearward direction and extends to the upper side of the light shielding wall 2b in the upward-downward direction. The vehicular display device 1D is configured to include the housing 2, the displays 3Ba and 3Bb, the transparent cover 5B, the half wave plate 10, and the reflecting mirrors 7A, 9A, and 7B.

The display 3Ba emits the display image projected onto the combiner 20 as display light and has the same configuration as that of the display 3B described above. In other words, the display 3Ba emits linearly polarized light vibrating in the reference vibration direction as the display light L1. Meanwhile, the display 3Bb emits linearly polarized light vibrating in a direction orthogonal to the reference vibration direction. In other words, the display 3Bb has a polarizing axis in the horizontal direction and emits the display light L3 parallel to the polarizing axis. For example, the display 3Bb is disposed such that the polarizing axis (transmission axis) of one of the polarizing plates that constitute the liquid crystal panel, which is on the light emitting side, is in the horizontal direction.

The transparent cover 5B of the present embodiment is configured to reflect the display light emitted from the display 3Ba toward the half wave plate 10 and transmit the display light reflected from the reflecting mirror 7B toward the combiner 20. Further, the transparent cover 5B is configured to transmit the display light reflected from the reflecting mirror 7A toward the windshield 101. The transparent cover 5B of the present embodiment has the light shielding wall 2b described above. The combiner 20 is disposed above the light shielding wall 2b in the upward-downward direction.

The half wave plate 10 is disposed at a position that is on the optical path of the display light and faces the transparent cover 5B. The half wave plate 10 transmits the display light incident from a transparent cover 5B toward the reflecting mirror 7B. The half wave plate 10 is a type of so-called wave plate, and a birefringent material or the like constitutes the half wave plate 10. The half wave plate 10 is obtained by giving a phase difference (optical path difference) to two linearly polarized light beams that have vibration directions orthogonal to each other. Using the vibration direction of the display light emitted from the display 3Ba as the reference vibration direction, the half wave plate 10 of the present embodiment converts the display light incident from the transparent cover 5B and transmitted to the reflecting mirror 7B side into the display light L3 vibrating in a direction tilted by 90° with respect to the reference vibration direction. In other words, as illustrated in FIG. 6, the half wave plate 10 converts the linearly polarized light (display light L1) reflected by the convex curved surface 5a of the transparent cover 5B into linearly polarized light (display light L3) vibrating in a direction orthogonal to the reference vibration direction. In this manner, the half wave plate 10 converts the polarizing axis of transmitted linearly polarized light into the horizontal direction from the vertical direction.

The reflecting mirrors 7A and 9A of the present embodiment are at positions where the optical path of the display light from the display 3Bb to the windshield 101 is folded back and reflect the display light. The reflecting mirrors 7A and 9A are optical systems that change the optical path of the display light emitted from the display 3Bb in the housing 2. The reflecting mirrors 7A and 9A of the present embodiment are magnifying mirrors. The reflecting mirrors 7A and 9A are formed of, for example, a mirror having a concave curved (or convex curved) reflecting surface. The reflecting mirror 9A of the present embodiment totally reflects the display light emitted from the display 3Bb toward the reflecting mirror 7A. The reflecting mirror 7A of the present embodiment totally reflects the display light reflected by the reflecting mirror 9A toward the windshield 101. Although the reflecting mirror 7A is fixed to the housing 2, the reflecting mirror 7A may be supported by an adjustment mechanism for finely adjusting the reflection angle of display light with which the windshield 101 is irradiated.

The reflecting mirror 7B according to the present embodiment is at a position where the optical path of the display light from the display 3Ba to the combiner 20 is folded back and reflects the display light. The reflecting mirror 7B is an optical system that changes the optical path of the display light emitted from the display 3Ba in the housing 2. The reflecting mirror 7B of the present embodiment is a magnifying mirror. The reflecting mirror 7B is formed of, for example, a concave mirror that has a free-form surface which has a concave reflecting surface. In other words, the reflecting mirror 7B magnifies and reflects the display image such that the display image represented by the display light after reflection by the reflecting mirror 7B becomes relatively larger than the display image represented by the display light before reflection by the reflecting mirror 7B. The reflecting mirror 7B of the present embodiment totally reflects the display light reflected by the transparent cover 5B toward the combiner 20. Although the reflecting mirror 7B is fixedly supported by the housing 2, the reflecting mirror 7B may be supported by an adjustment mechanism for finely adjusting the reflection angle of display light with which the combiner 20 is irradiated.

Next, a display operation of the vehicular display device 1D will be described with reference to FIG. 5. First, the display light emitted from the display 3Ba is directed to the transparent cover 5B. The transparent cover 5B reflects the display light incident from the display 3Ba toward the half wave plate 10 by the convex curved surface 5a. The half wave plate 10 transmits the display light incident from the transparent cover 5B toward the reflecting mirror 7B. The display light incident upon the reflecting mirror 7B is totally reflected by the concave reflecting surface and directed to the transparent cover 5B again. The transparent cover 5B transmits the display light incident from the reflecting mirror 7B from the convex curved surface 5a toward the combiner 20 via the concave curved surface 5b. As a result, the display image is projected onto the combiner 20 and the virtual image 111 is displayed in front of the eye point 201 of the driver 200.

On the other hand, the display light emitted from the display 3Bb is directed to the reflecting mirror 9A. The display light incident upon the reflecting mirror 9A is totally reflected by the concave reflecting surface and directed to the reflecting mirror 7A. The reflecting mirror 7A totally reflects the display light incident from the reflecting mirror 9A toward the transparent cover 5B. The transparent cover 5B transmits the display light incident from the reflecting mirror 7A from the convex curved surface 5a toward the windshield 101 via the concave curved surface 5b. As a result, the display image is projected onto the windshield 101 and the virtual image 110 is displayed in front of the eye point 201 of the driver 200.

In the vehicular display device 1D described above, the transparent cover 5B reflects the first linearly polarized light emitted from the display 3Ba and transmits the second linearly polarized light converted from the first linearly polarized light by the half wave plate 10 toward the windshield 101. By the transparent cover 5B being given a function as a polarizing plate and the display light being reflected and transmitted by means of the transparent cover 5B in this manner, it is possible to obtain effects identical to the effects of the vehicular display device 1C.

Although the reflecting mirrors 7B and 9B have a function as a magnifying mirror in the second and third embodiments, the present invention is not limited thereto, and the reflecting mirrors 7B and 9B may also have a function as the above-described correction mirror. The reflecting mirrors 7B and 9B that function as the magnifying mirror and the correction mirror are formed as free-form surface mirrors having shapes asymmetrical with respect to an optical axis unlike a spherical surface and a paraboloid.

In addition, in the second and third embodiments, the transparent cover 5B has a shape in which the convex curved surface 5a corrects a field curvature aberration. As a result, it is possible to correct display distortion of the display image represented by the display light by display light reflection on the convex curved surface 5a of the transparent cover 5B, and display quality improvement can be achieved.

In addition, in the second and third embodiments, the transparent cover 5B has a polarization function by a polarizing film being affixed to the convex curved surface 5a side. However, the present invention is not limited thereto, and the transparent cover 5B may have a polarization function by a polarizing film being affixed to the concave curved surface 5b side. In addition, the transparent cover 5B may be a cover integrally molded with a light-transmitting member and a polarizing plate.

In the first embodiment, the modification example, the second embodiment, and the third embodiment described above, a case where a vehicular display device 1 is applied to the vehicle 100 has been described. However, the present invention is not limited thereto. The present invention may also be applied to those other than the vehicle 100, examples of which include ships and aircrafts.

With the vehicular display device according to the present embodiment, a display screen can be expanded and a housing can be reduced in size.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicular display device comprising:
a display that emits, as display light, a display image projected onto a projected member provided in a vehicle;
a cover member that blocks an opening provided in a housing and transmits at least a part of the display light; and
a reflecting member that reflects the display light at a position where an optical path of the display light from the display to the projected member is folded back, wherein
the cover member includes a light shielding wall erected in a front edge portion of the vehicle in a forward-rearward direction and disposed on an optical path of external light incident from an outside of the vehicle, reflected by the cover member, and directed from the cover member to an eye point of a driver of the vehicle via the projected member, and
the cover member reflects the display light emitted from the display toward the reflecting member, transmits the display light reflected from the reflecting member toward the projected member, and reflects the external light toward the light shielding wall.

2. The vehicular display device according to claim 1, wherein
the cover member has a convex curved surface shape protruding toward an inside of the housing.

3. The vehicular display device according to claim 1, wherein
the cover member has a convex curved surface shape tilted to a front side in the forward-rearward direction and protruding toward an inside of the housing.
